(19) United States
(12) Patent Application Publication
(10) Pub. No.: US 2009/0035486 A1
(43) Pub. Date: Feb. 5, 2009

(54) Sealants and display device including the same

(75) Inventor: Ki-Chul Shin, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/218,853

(22) Filed: Jul. 18, 2008

(30) Foreign Application Priority Data
Jul. 30, 2007 (KR) 10-2007-0076404

(51) Int. Cl. C08G 73/16; C09K 19/52; B32B 27/38

(52) U.S. Cl. 428/1.53; 428/414; 528/289; 524/602

(57) ABSTRACT

A sealant is provided. The sealant includes an acrylic type compound having at least two acrylic groups per one molecule, an epoxy type compound having at least one epoxy group per one molecule, and a dihydrazide compound. The dihydrazide compound includes 4-isopropyl-2,5-dioxoimidazolidin-1,3-di(propyonohydrazide) and adipic acid dihydrazide. A display device is also provided. The display device includes a pair of substrates and a sealing pattern between the pair of substrates. The sealing pattern includes the sealant.

### CROSS-REFERENCE TO RELATED APPLICATION

This U.S. non-provisional patent application claims priority under 35 U.S.C § 119 to Korean Patent Application 2007-76404, filed on Jul. 30, 2007, the entirety of which is hereby incorporated by reference.

### BACKGROUND

The present invention relates to sealants and display device including the same.

In general, display device includes such devices as a liquid crystal display (LCD) device, a plasma display panel (PDP) device, and an organic light emitting display (OLED) device. The display device has been widely employed in large-sized television sets, notebook computers, and mobile phones.

The display device such as the LCD device includes a pair of substrates facing each other and a liquid crystal layer therebetween. When an electric field is applied to some portions of the liquid crystal layer, liquid crystals in the liquid crystal layer are arrayed toward some specific directions to exhibit a specific visual image.

When the area exhibiting the visual image is referred to as a display area, the display area is allocated at a center region of the respective substrates. In other words, the display area is surrounded by an edge of the respective substrates. A sealing pattern is formed on the edge of one of the substrates, and the pair of the substrates is adhered to each other by the sealing pattern. However, one of the substrates may be misaligned with the other substrate when the substrates are adhered to each other. In particular, as the display device becomes more enlarged, the misalignment between the pair of substrates has more frequently occurred.

### SUMMARY

Embodiments of the present invention are directed to a sealant and a display device including the same. In one embodiment, the sealant includes an acrylic type compound, an epoxy type compound and a dihydrazide compound. The acrylic type compound has at least two acrylic groups per one molecule, and the epoxy type compound has at least one epoxy group per one molecule. The dihydrazide compound includes 4-isopropyl-2,5-dioxoimidazolidin-1,3-di(propyonohydrazide) and adipic acid dihydrazide.

In another embodiment, the display device includes a first substrate having a display area, a second substrate facing the first substrate, and a sealing pattern disposed between the first and second substrates to attach the first substrate to the second substrate. The sealing pattern includes a sealant. The sealant includes an acrylic type compound having at least two acrylic groups per one molecule, an epoxy type compound having at least one epoxy group per one molecule, and a dihydrazide compound. The dihydrazide compound includes 4-isopropyl-2,5-dioxoimidazolidin-1,3-di(propyonohydrazide) and adipic acid dihydrazide.

### BRIEF DESCRIPTION OF THE DRAWINGS

FIG. 1 is an exploded perspective view illustrating a liquid crystal display device according to an embodiment of the present invention.

FIG. 2 is a cross sectional view illustrating a portion of the liquid crystal display device shown in FIG. 1.

FIG. 3 is a graph illustrating differential scanning calorimetry (DSC) analysis results of conventional sealants and various sealants according to some embodiments of the present invention.

FIG. 4 is a histogram illustrating adhesion of various sealants according to a conventional art and an embodiment of the present invention.

FIG. 5A illustrates an alignment state between a pair of substrates of conventional display device.

FIG. 5B illustrates an alignment state between a pair of substrates of a plurality of display device fabricated using a sealant according to an embodiment of the present invention.

FIGS. 6A to 6E are perspective views illustrating methods of fabricating a display device according to an embodiment of the present invention.

### DETAILED DESCRIPTION

The present invention will now be described more fully hereinafter with reference to the accompanying drawings, in which embodiments of the invention are shown. This invention, however, may be embodied in many different forms and should not be construed as limited to the embodiments set forth herein. Rather, these embodiments are provided so that this disclosure will be thorough and complete, and will convey the scope of the invention to those skilled in the art. In the drawings, the thicknesses of layers and regions (or areas) are exaggerated for clarity. It will also be understood that when a layer is referred to as being “on” another layer or substrate, it can be directly on the other layer or substrate, or intervening layers may also be present, whereas when a layer is referred to as being “directly on” another layer or substrate, no intervening layers are present. Like numbers refer to like elements throughout.

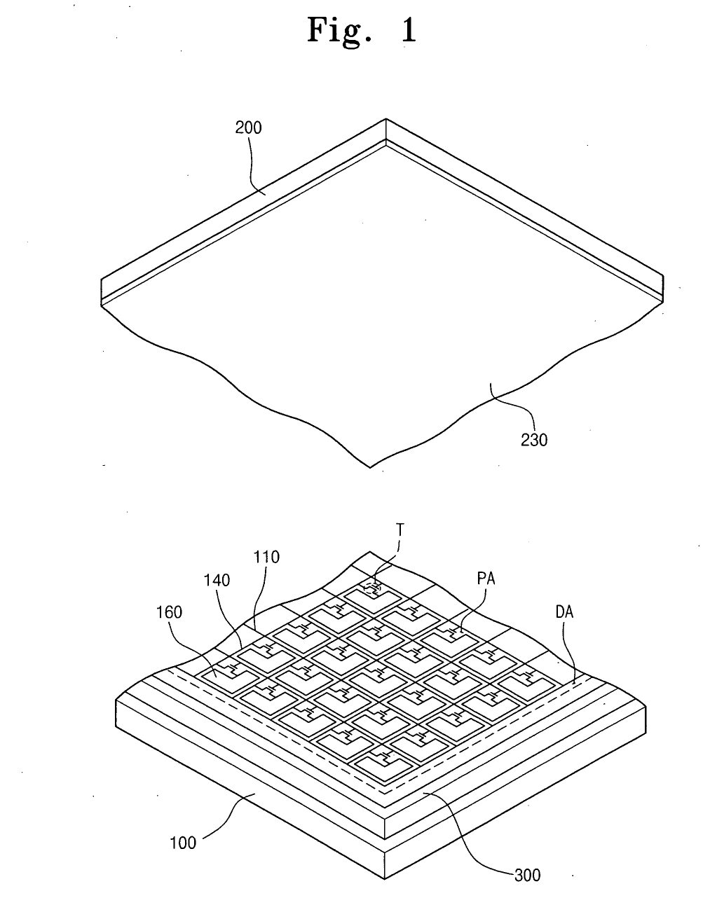

FIG. 1 is an exploded perspective view illustrating a liquid crystal display (LCD) device according to an embodiment of the present invention.

Referring to FIG. 1, a first substrate 100 and a second substrate 200 are provided. A liquid crystal layer having a number of liquid crystals may be disposed between the first and second substrates 100 and 200. The first substrate 100 may have a display area DA which exhibits a visual image. The display area DA may correspond to an inside region including a center region, which is surrounded by an edge of the first substrate 100.

A sealing pattern 300 may be disposed on the edge of the first substrate 100. That is, the sealing pattern 300 may be disposed on an outside region of the display area DA of the first substrate 100. Alternatively, the sealing pattern 300 may be disposed on an edge of the second substrate 200, which faces the edge of the first substrate 100.

A plurality of gate lines 110 and a plurality of data lines 140 are disposed on the display area DA of the first substrate 100. The gate lines 110 are disposed across the data lines 140, and a plurality of pixel areas PA are located at intersections between the gate lines 110 and the data lines 140. Each of the pixel areas PA may include a pixel electrode 160 and a thin film transistor T which is electrically connected to the pixel electrode 160.

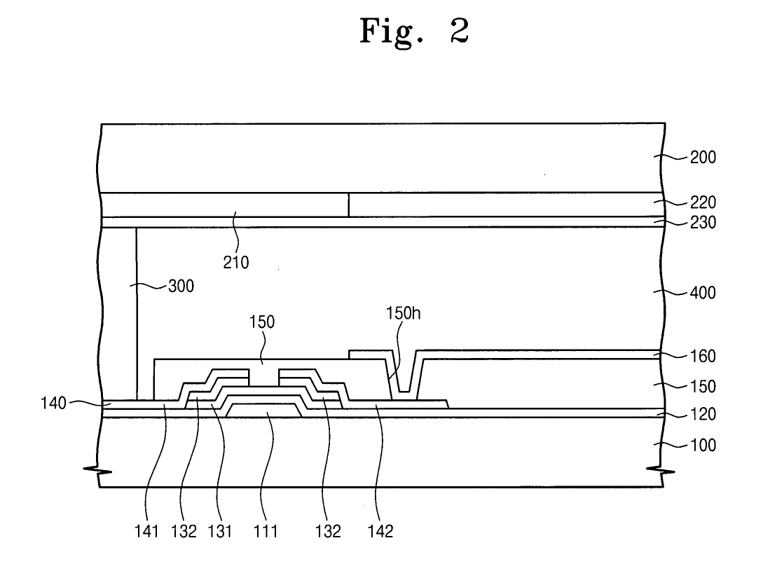

FIG. 2 is a cross sectional view illustrating a portion of the LCD device shown in FIG. 1.

Referring to FIG. 2, the first and second substrates 100 and 200 are attached to each other by the sealing pattern 300 having a predetermined thickness. Thus, the display area DA of the first substrate 100 is spaced apart from the second substrate 200. That is, a space surrounded by the sealing pattern 300 may exist between the first and second substrates 100 and 200. The space between the first and second substrates 100 and 200 is filled with a liquid crystal layer 400. A gate electrode 111 is disposed on the display area DA of the first substrate 100. The gate electrode 111 is electrically connected to one of the gate lines 110 illustrated in FIG. 1. A gate insulating layer 120 is formed on the gate electrode 111.

A semiconductor pattern 131, which acts as a channel body, is disposed on the gate insulating layer 120. The semiconductor pattern 131 may fully overlap with the gate electrode 111. A pair of ohmic contact patterns 132 are disposed on the semiconductor pattern 131 and spaced apart from each other. The pair of ohmic contact patterns 132 may overlap with both ends of the gate electrode 111, respectively. A source electrode 141 and a drain electrode 142 may be disposed on the pair of ohmic contact patterns 132, respectively. The source electrode 141 may extend to act as one of the data lines 140 illustrated in FIG. 1. The gate electrode 111, the source electrode 141 and the drain electrode 142 constitute the thin film transistor T shown in FIG. 1.

The thin film transistor T may be covered with a protection layer 150. A pixel electrode 160 is disposed on the protection layer 150, and the pixel electrode 160 is electrically connected to the drain electrode 142 through a contact hole 150h formed through the protection layer 150. The thin film transistor T, the protection layer 150 and the pixel electrode 160 may be disposed between the liquid crystal layer 400 and the first substrate 100.

An optical blocking layer pattern 210 is disposed between the second substrate 200 and the liquid crystal layer 400. The optical blocking layer pattern 210 may have an opening which is located over the pixel electrode 160. A color filter 220 is disposed in the opening of the optical blocking layer pattern 210. A common electrode 230 is disposed between the color filter 220 and the liquid crystal layer 400. That is, the common electrode 230 may be disposed to face the pixel electrode 160.

In order to operate the LCD device, a gate signal is applied to the gate line 110 connected to the gate electrode 111, thereby turning on the thin film transistor T. Further, a data signal is applied to the data line 140 while the gate signal is applied to the gate line 110. The data signal may have a predetermined value according to a desired visual image. Thus, a data output voltage corresponding to the desired visual image may be generated at the pixel electrode 160. In addition, a common voltage is applied to the common electrode 230 while the data signal is applied. Therefore, liquid crystals of the liquid crystal layer 400 between the pixel electrode 160 and the common electrode 230 may be arrayed along a specific direction due to an electric field induced between the pixel electrode 160 and the common electrode 230. Light permeability of the liquid crystal layer 400 may change depending on the array state of the liquid crystals therein. Thus, a desired visual image may be displayed on the LCD device by adjusting the voltage difference between the pixel electrode 160 and the common electrode 230 as well as by irradiating backlights onto the backside of the first substrate 100.

As described above, the LCD device may exhibit a visual image using the backlights penetrating the liquid crystal layer 400 and the electric field between the pixel electrode 160 and the common electrode 230. Accordingly, when the liquid crystal layer 400 is contaminated, quality of the visual image may be degraded.

The sealing pattern 300 may comprise at least one compound material for attaching the first substrate 100 to the second substrate 200. If some compositions in the sealing pattern 300 are diffused into the liquid crystal layer 400, the liquid crystal layer 400 may be contaminated. Moreover, if the sealing pattern 300 has low adhesion, the misalignment between the first and second substrates 100 and 200 may occur when the first and second substrates 100 and 200 are attached to each other.

The sealing pattern 300 may be formed of a sealant which comprises acrylic type compound, epoxy type compound and dihydrazide compound in one example.

The acrylic type compound may have at least two acrylic groups per one molecule. The acrylic type compound may comprise at least one of the first to fourth compounds which are expressed by the following chemical formulas 1 to 4 respectively.

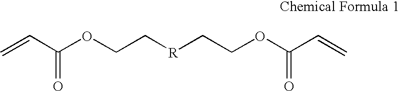

wherein, “R” denotes a hydrocarbon (HC) group.

As can be seen from the chemical formula 1, the first compound has one hydrocarbon group R and two sub-compounds combined with the hydrocarbon group R. The hydrocarbon group R may have at least one carbon atom. When the hydrocarbon group R has one carbon atom in the chemical formula 1, the hydrocarbon group R may be expressed by a formula “CH₂”. The two sub-compounds may have the same chemical structure as shown in the chemical formula 1, and each of the sub-compounds may have one acrylic group at an end thereof. As a result, the first compound may have two acrylic groups per one molecule.

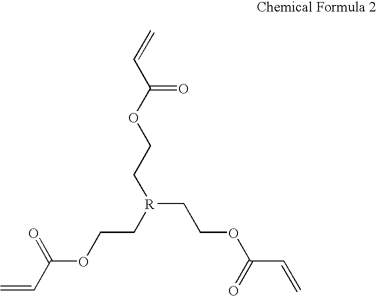

wherein, “R” denotes a hydrocarbon (HC) group.

As can be seen from the chemical formula 2, the second compound has one hydrocarbon group R and three sub-compounds combined with the hydrocarbon group R. The hydrocarbon group R may have at least one carbon atom. When the hydrocarbon group R has one carbon atom in the chemical formula 2, the hydrocarbon group R may be expressed by a formula “CH”. The three sub-compounds may have the same chemical structure as shown in the chemical formula 2, and each of the sub-compounds may have one acrylic group at an end thereof. As a result, the second compound may have three acrylic groups per one molecule.

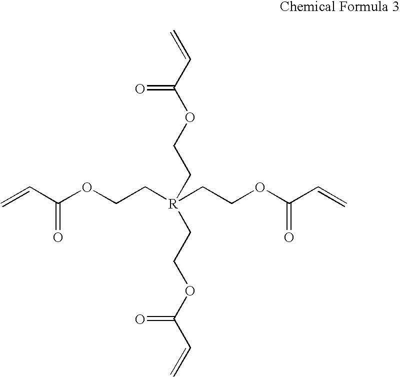

wherein, “R” denotes a hydrocarbon (HC) group.

As can be seen from the chemical formula 3, the third compound has one hydrocarbon group R and four sub-compounds combined with the hydrocarbon group R. The hydrocarbon group R may have at least one carbon atom. When the hydrocarbon group R has one carbon atom in the chemical formula 3, the hydrocarbon group R may be expressed by a formula “C”. The four sub-compounds may have the same chemical structure as shown in the chemical formula 3, and each of the sub-compounds may have one acrylic group at an end thereof. As a result, the third compound may have four acrylic groups per one molecule.

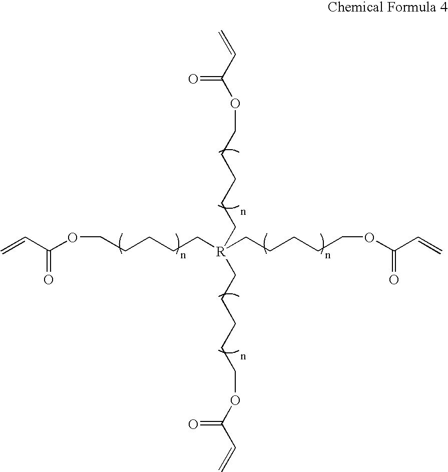

wherein, “R” denotes a hydrocarbon (HC) group, and “n” denotes a natural number.

As can be seen from the chemical formula 4, the fourth compound has one hydrocarbon group R and four sub-compounds combined with the hydrocarbon group R. The hydrocarbon group R may have at least one carbon atom. When the hydrocarbon group R has one carbon atom in the chemical formula 4, the hydrocarbon group R may be expressed by a formula “C”. The four sub-compounds may have the same chemical structure as shown in the chemical formula 4, and each of the sub-compounds may have one acrylic group at an end thereof. As a result, the fourth compound may also have four acrylic groups per one molecule.

The acrylic type compound including at least one of the first to fourth compounds may be cured using light such as ultraviolet (UV) light. In other words, the acrylic type compound may be cured by photo reaction which is due to light. In this case, the acrylic type compound may exhibit an improved curing efficiency. This is because the acrylic type compound has at least two acrylic groups per one molecule as described above and the acrylic groups act as bonding sites between the molecules of the acrylic type compound. In other words, the molecules of the acrylic type compound may be strongly bonded to each other during irradiation of the UV light since each of the molecules of the acrylic type compound has a plurality of acrylic groups. Thus, most molecules of the acrylic type compound may be bonded to each other during irradiation of the UV light, thereby increasing a volume of the cured portion and relatively reducing a volume of the uncured portion. The uncured portion of the acrylic type compound may exhibit a liquid state. That is, the uncured portion may have flowability. Thus, the more the volume of the uncured portion is increased, the more contaminated the liquid crystal layer 400 may become. However, the acrylic type compound according to the aforementioned embodiments may have an excellent curing efficiency as described above. Therefore, it can substantially prevent the liquid crystal layer 400 from being contaminated during fabrication of the LCD device.

The epoxy type compound may comprise a compound which has at least one epoxy group per one molecule. For example, the epoxy type compound may be novolak type epoxy resin, glycidyl ether of polyhydric phenol or glycidyl ether of polyhydric alcohol. The novolak type epoxy resin may be phenol novolak resin. Further, the glycidyl ether of polyhydric phenol may be resorcinol diglycidyl ether, and the glycidyl ether of polyhydric alcohol may be polypropylene glycol diglycidyl ether.

The epoxy type compound may be baked by heat. In this case, the epoxy type compound may be cured to have a three dimensional net-shaped structure. When the sealant including the acrylic type compound and the epoxy type compound is cured by heat, the epoxy type compound may be cured more slowly as compared to the acrylic type compound but the epoxy type compound may exhibit more excellent hardness or strength as compared to the acrylic type compound after the curing process. Thus, the acrylic type compound may be primarily used to prevent contamination of the liquid crystal layer and the epoxy type compound may be secondarily used to enhance the strength of the sealant. As a result, it is preferable that a weight percentage of the acrylic type compound is equal to or greater than that of the epoxy type compound. For example, a weight ratio of the acrylic type compound versus the epoxy type compound may be within a ratio of about 1:1 to about 5:1. In particular, when the weight percentage of the acrylic type compound is equal to or greater than four times that of the epoxy type compound, the content of the acrylic type compound may be relatively increased as compared to the content of the epoxy type compound, thereby enhancing elasticity and adhesive strength of the sealant.

The dihydrazide compound may comprise a first dihydrazide compound and a second dihydrazide compound which are different from each other. The first dihydrazide compound may be 4-isopropyl-2,5-dioxoimidazolidine-1,3-di(propyonohydrazide) which is expressed by the following chemical formula 5, and the second dihydrazide compound may be adipic acid dihydrazide which is expressed by the following formula 6.

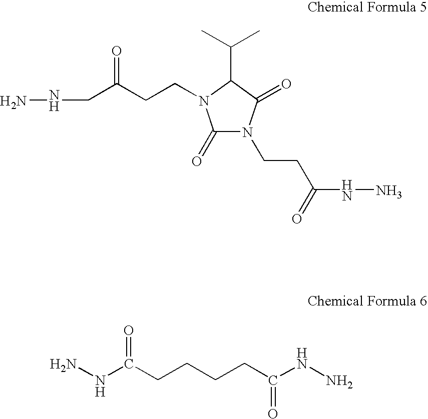

The first and second dihydrazide compounds may have a first melting point of about 120° C. and a second melting point of about 180° C., respectively. The first dihydrazide compound may exhibit relatively high reactivity as compared to the second dihydrazide compound since the first melting point is lower than the second melting point. Further, the second dihydrazide compound may be relatively more stable as compared to the first dihydrazide compound since the second melting point is higher than the first melting point.

When a thermal treatment process is performed to cure the sealing pattern 300, viscosity of the sealing pattern 300 may become lowered as the time lapses during an initial stage of the thermal treatment process and become increased after the initial stage of the thermal treatment process. If the viscosity of the sealing pattern 300 becomes lowered, the compounds in the sealing pattern 300 may easily flow into the liquid crystal layer 400 to contaminate the liquid crystal layer 400. Thus, the liquid crystal layer 400 may be easily contaminated due to the low viscosity of the sealing pattern 300 during the initial stage of the thermal treatment process. However, the first dihydrazide compound included in the sealing pattern 300 according to present invention has a low melting point of about 120° C. as described above. Thus, the first dihydrazide compound included in the sealing pattern 300 according to present invention may rapidly react even during the initial stage of the thermal treatment process, thereby preventing the liquid crystal layer 400 from being contaminated. In the meantime, the viscosity and the adhesive strength of the sealing pattern 300 may be enhanced because of the presence of the second dihydrazide compound having a high melting point of about 180° C.

As described above, the first dihydrazide compound may act to prevent the contamination of the liquid crystal layer 400, and the second dihydrazide compound may secondarily act to enhance the adhesive strength of the sealing pattern 300. Accordingly, it is preferable that a weight percentage of the first dihydrazide compound is greater than that of the second dihydrazide compound. For example, a weight ratio of the first dihydrazide compound versus the second dihydrazide compound may be within a ratio of about 7:2 to about 9:2.

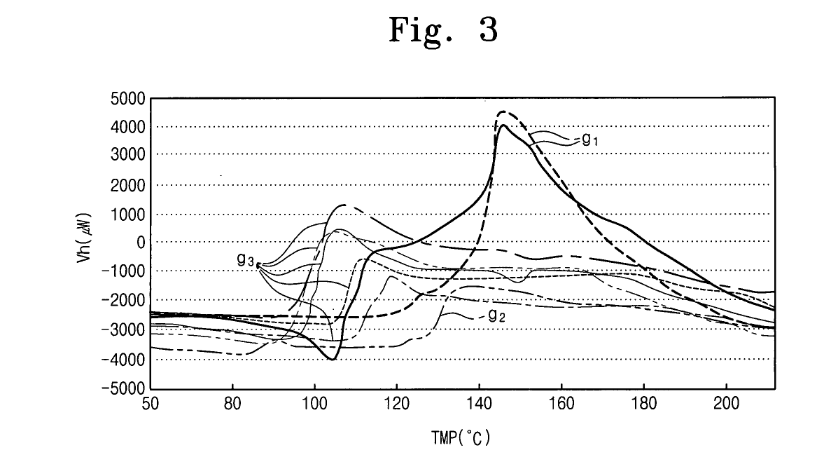

FIG. 3 is a graph illustrating differential scanning calorimetry (DSC) analysis results of conventional sealants and various sealants according to some embodiments of the present invention. In FIG. 3, the abscissa represents a temperature TMP of the sealants, and the ordinate represents variation Vh of heat generated from the sealants. The heat variation Vh of the sealants was measured using the differential scanning calorimetry (DCS) instrument and indicated in a unit of micro watt (SW). The heat variation Vh may correspond to an enthalpy variation.

Referring to FIG. 3, the sealants for test may be classified into three groups g1, g2 and g3. The first group of sealants g1 was formed not to include the acrylic type compound having at least one of the first to fourth compounds expressed by the chemical formulas 1 to 4 respectively. That is, the sealants g1 were formed not to include the first to fourth compounds expressed by the chemical formulas 1 to 4. The second group of sealants g2 was formed to include the first to fourth compounds expressed by the chemical formulas 1 to 4 respectively and the first dihydrazide compound expressed by the chemical formula 5, and the third group of sealants g3 was formed to include the first to fourth compounds expressed by the chemical formulas 1 to 4 respectively and the first and second dihydrazide compounds expressed by the chemical formulas 5 and 6 respectively.

As can be seen from FIG. 3, the first to third groups of sealants g1, g2 and g3 exhibited peak points at predetermined temperatures. The peak points correspond to change points of states of the sealants. The first group of sealants g1 exhibited the peak points at a temperature higher than about 140° C. This may be understood as that the first group of sealants g1 was cured at a relatively high temperature. As a result, it could be understood that the first group of sealants g1 was slowly cured to include a lot of uncured portions therein during a thermal treatment process. The uncured portions of the first group of sealants g1 may increase the probability of contamination of the liquid crystal layer adjacent thereto. In contrast, the second and third groups of sealants g2 and g3 exhibited peak points at temperatures lower than about 140° C. This may be understood as that the second and third groups of sealants g2 and g3 were cured at a relatively low temperature as compared to the first group of sealants g1. As a result, it could be understood that the second and third groups of sealants g2 and g3 were rapidly cured to include few uncured portions therein during a thermal treatment process. Thus, the probability of contamination of the liquid crystal layer adjacent to the second and third groups of sealants g2 and g3 may be significantly lowered.

Further, it could be understood that the third group of sealants g3 was cured at a relatively low temperature as compared to the second group of sealants g2. In addition, the heat variation Vh of the second group of sealants g2 was non-uniform within a low temperature range, whereas the heat variation Vh of the third group of sealants g3 was uniform within a low temperature range. This may be understood that the third group of sealants g3 has more stable viscosity as compared to the second group of sealants g2. As a result, the third group of sealants g3 may have excellent adhesion to prevent the first and second substrates 100 and 200 from being misaligned with each other during fabrication of the LCD device.

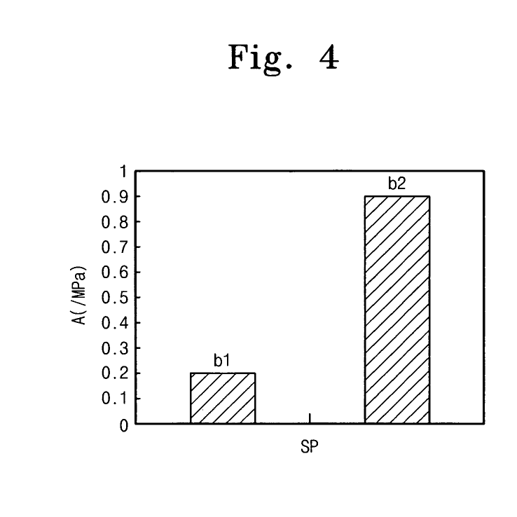

FIG. 4 is a histogram illustrating adhesion of various sealants according to a conventional art and an embodiment of the present invention. In FIG. 4, the abscissa represents split groups of sealing patterns SP, and the ordinate represents adhesion A of the sealing patterns.

Referring to FIG. 4, conventional sealing patterns b1 without the first and second dihydrazide compounds expressed by the chemical formulas 5 and 6 exhibited a low adhesion A of about 0.2 (MPa). In contrast, the sealing patterns b2 according to an embodiment of the present invention exhibited a relatively high adhesion A of about 0.9 (MPa) as compared to the conventional sealing pattern b1. The sealing pattern b2 was formed to include the first and second dihydrazide compounds expressed by the chemical formulas 5 and 6.

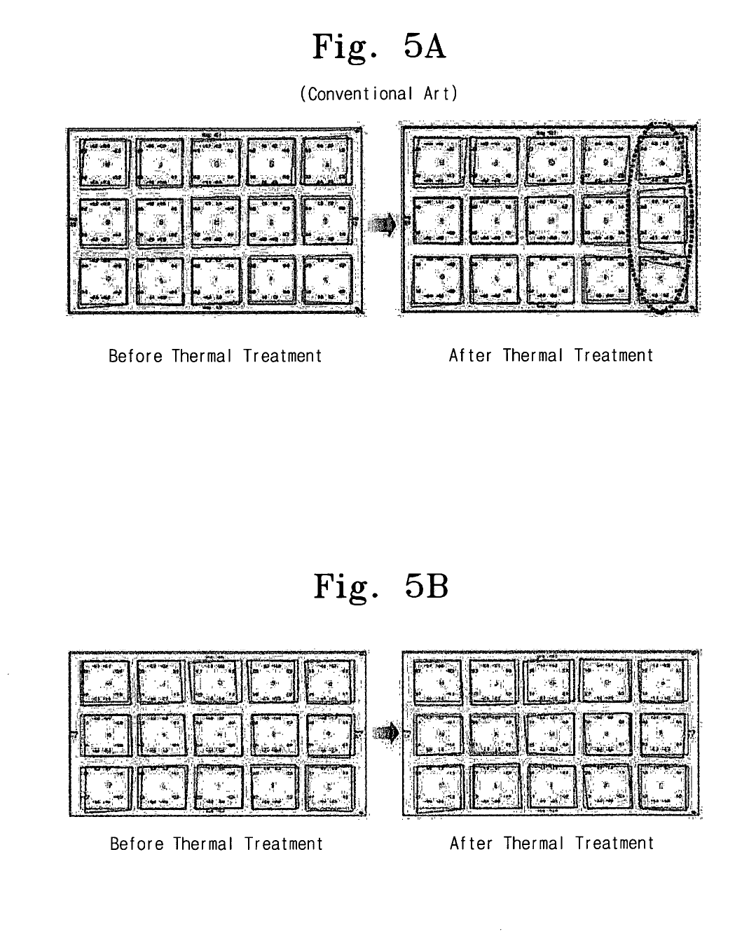

FIG. 5A illustrates an alignment state between a pair of substrates of a plurality of conventional display device, and FIG. 5B illustrates an alignment state between a pair of substrates of a plurality of display device fabricated using a sealant according to an embodiment of the present invention.

Referring to FIG. 5A, a first substrate (e.g., an upper substrate) and a second substrate (e.g., a lower substrate) are aligned to overlap with each other prior to a thermal treatment process. The first and second substrates constitute a substrate set, and the substrate set includes fifteen LCD panel regions which are two dimensionally arrayed along three rows and five columns. The first and second substrates are combined with each other by a conventional sealant therebetween. The conventional sealant does not include any of the first and second dihydrazide compounds. When the thermal treatment process is applied to the substrate set including the conventional sealant, a portion of the substrate set is thermally expanded or warped to cause a misalignment between the first and second substrates. That is, a portion of the first substrate is misaligned with the corresponding portion of the second substrate after the thermal treatment process, as indicated by a circle in FIG. 5A. This may be due to weak adhesion of the conventional sealant. In particular, the misalignment between the first and second substrates may occur at an edge of the substrate set during the thermal treatment process.

Referring to FIG. 5B, a first substrate (e.g., an upper substrate) and a second substrate (e.g., a lower substrate) are aligned to overlap with each other prior to a thermal treatment process. The first and second substrates constitute a substrate set, and the substrate set also includes fifteen LCD panel regions which are two dimensionally arrayed along three rows and five columns. The first and second substrates are combined with each other by a sealant including the first and second dihydrazide compounds expressed by the chemical formulas 5 and 6. When the thermal treatment process is applied to the substrate set including the sealant which has the first and second dihydrazide compounds, the substrate set is hardly deformed to substantially maintain the initial alignment state between the first and second substrates as shown in FIG. 5B. This is because the sealant including the first and second dihydrazide compounds has strong adhesion during the thermal treatment process to suppress the deformation of the substrate set.

As described above, the sealing pattern 300 including the sealant according to some embodiments of the present invention may prevent the liquid crystal layer 400 from being contaminated and may suppress the deformation of the substrate set.

In some other embodiments, the sealant may further comprise a hybrid compound and a filler in addition to the acrylic type compound, the epoxy type compound and the dihydrazide compound. An example of the hybrid compound may be expressed by the following chemical formula 7. As illustrated in FIG. 7, the hybrid compound may have an acrylic group and an epoxy group. The hybrid compound may be cured by either heat or photo light.

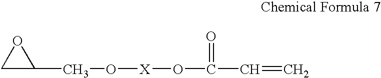

The filler may comprise both an inorganic filler and an organic filler. The inorganic filler may be, for example, silica. The inorganic filler may prevent shrinkage of the sealing pattern 300 formed of the sealant and may enhance adhesion of the sealing pattern 300 formed of the sealant, when the sealing pattern is cured. The organic filler may be, for example, acrylic resin. The organic resin has a soft and flexible property to alleviate a physical stress applied to the sealing pattern 300. That is, the organic resin may act as a buffer of the sealing pattern 300.

As described above, the sealant may comprise the acrylic type compound, the epoxy type compound, the dihydrazide compound, the hybrid compound, the inorganic filler and the organic filler. In this case, the content of the acrylic type compound and the epoxy type compound may be higher than the content of the dihydrazide compound, the hybrid compound, the inorganic filler and the organic filler in weight percentage. The hybrid compound may correspond to a subsidiary material of the acrylic type compound and the epoxy type compound. Accordingly, the hybrid compound content may be lower than the acrylic type compound content or the epoxy type compound content. Further, the dihydrazide compound content and the filler content may be lower than the acrylic type compound content or the epoxy type compound content. The inorganic filler content may be higher than the organic filler content to increase the adhesion of the sealing pattern 300.

When the sealant includes the acrylic type compound, the epoxy type compound, the dihydrazide compound, the hybrid compound, the inorganic filler and the organic filler, the sealant may comprise the acrylic type compound of 32 to 38 wt %, the epoxy type compound of 23 to 29 wt %, the dihydrazide compound of 8 to 12 wt %, the hybrid compound of 7 to 11 wt %, the inorganic filler of 12 to 16 wt % and the organic filler of 3 to 7 wt %. Preferably, the sealant may comprise the acrylic type compound of 35.5 wt %, the epoxy type compound of 26 wt %, the dihydrazide compound of 10.5 wt %, the hybrid compound of 9 wt %, the inorganic filler of 14 wt % and the organic filler of 5 wt %.

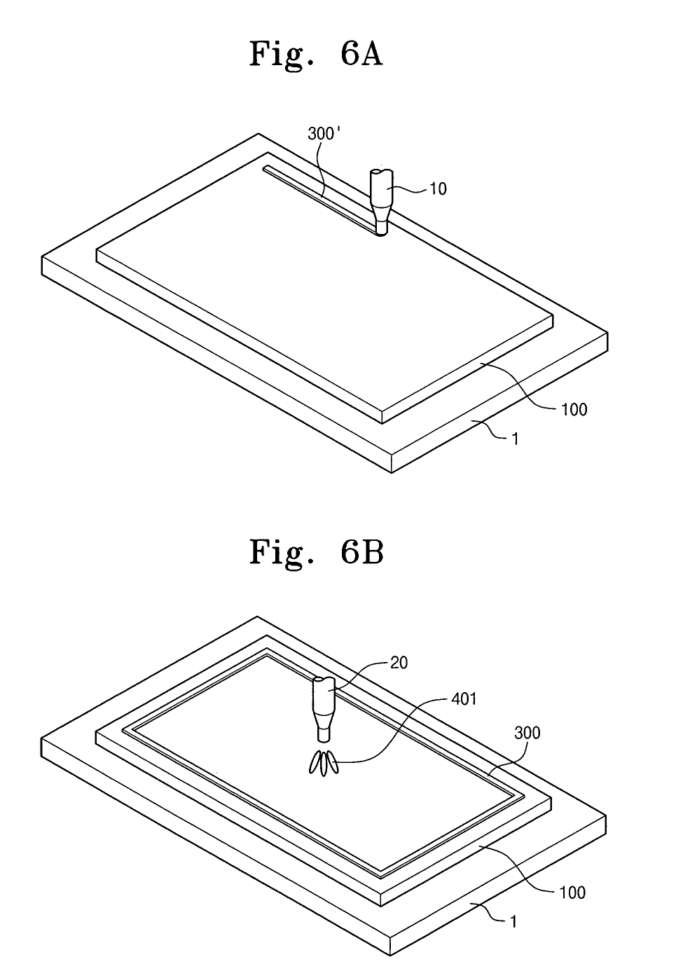

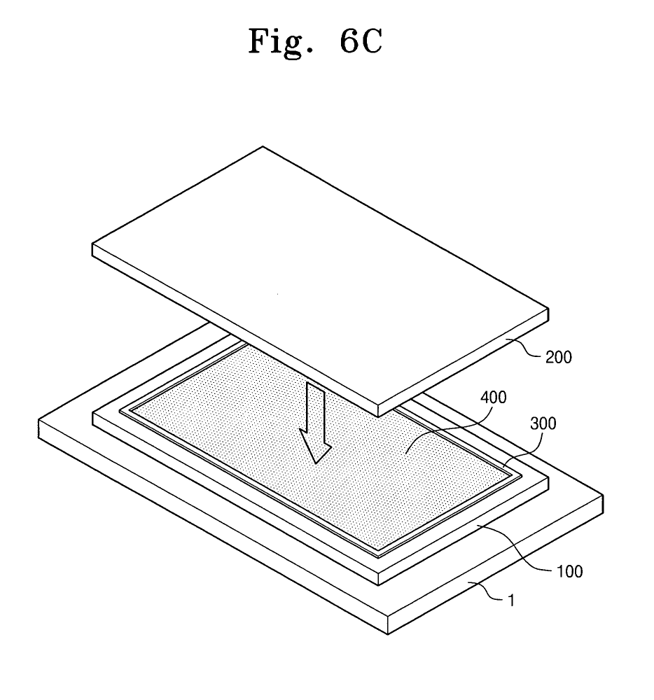

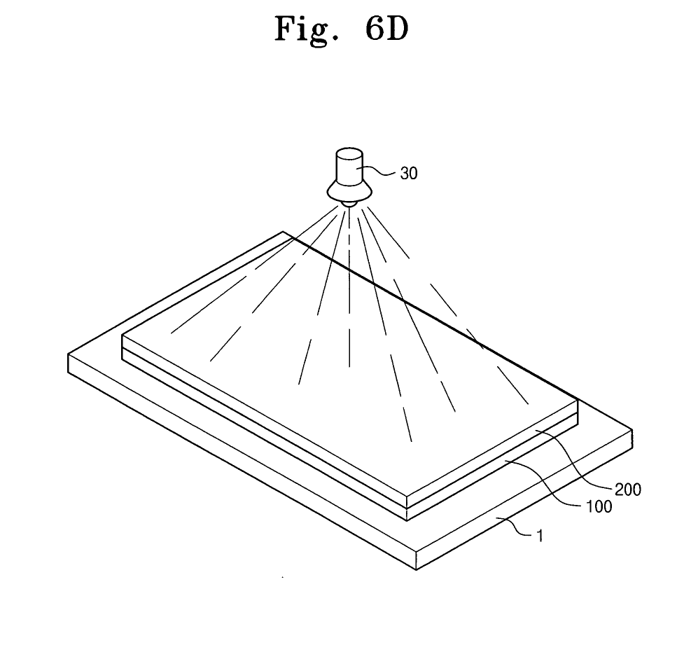

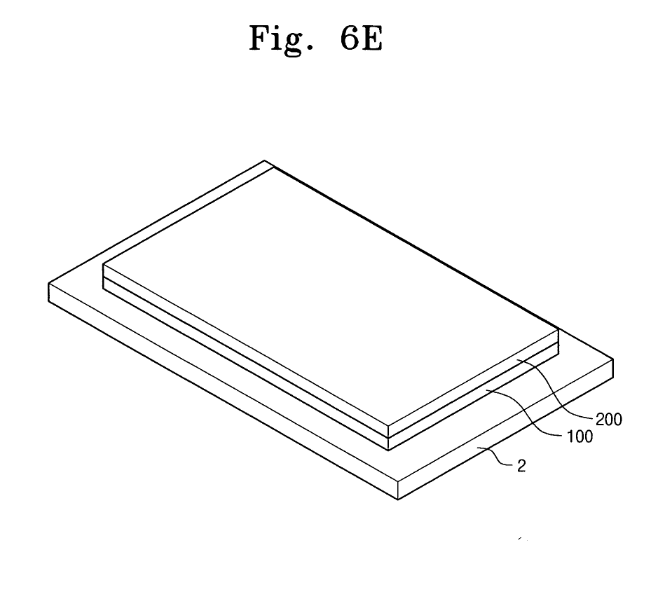

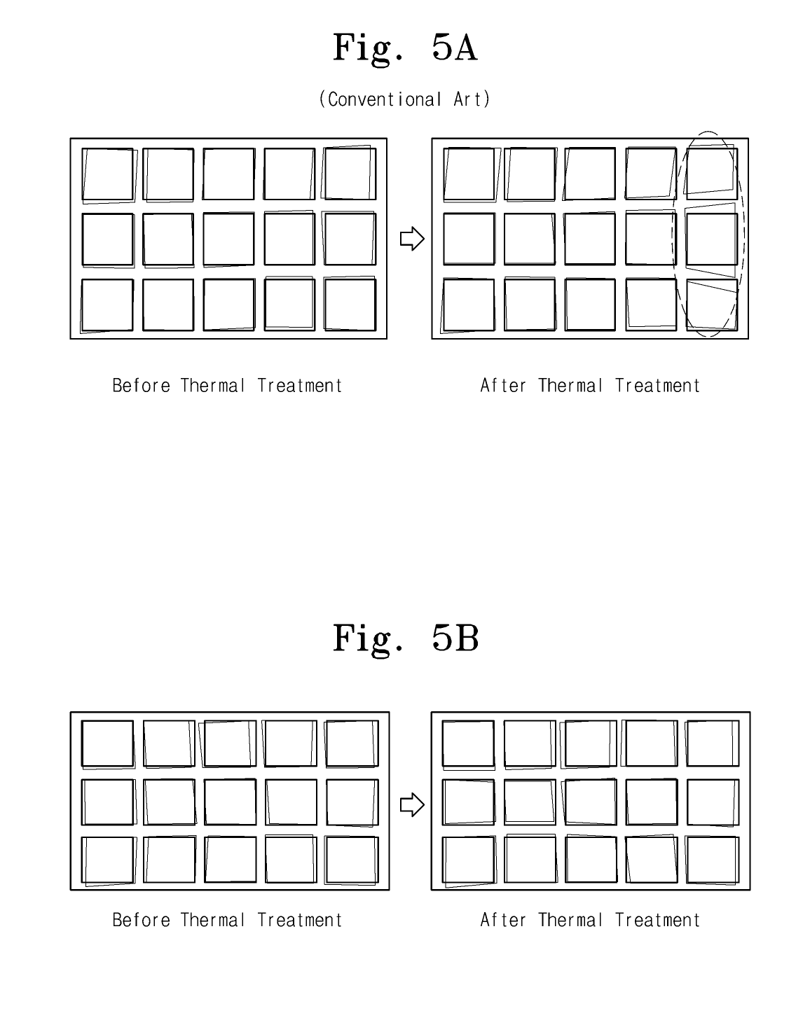

Now, methods of fabricating an LCD device according to an embodiment of the present invention will be described with reference to perspective views of FIGS. 6A to 6E.

Referring to FIG. 6A, a first substrate 100 may be provided on a stage 1. The first substrate 100 may be a transparent substrate. A first dispenser 10 may be located over the first substrate 100. A sealant 300′ may be supplied into the first dispenser 10, and the first dispenser 10 may move along an edge of the first substrate 100. The first dispenser 10 may dispense the sealant 300′ on the edge of the first substrate 100 while moving along the edge of the first substrate 100. The sealant 300′ may comprise an acrylic type compound having at least two acrylic groups per one molecule, an epoxy type compound and a dihydrazide compound.

Referring to FIG. 6B, the sealant 300′ dispensed onto the edge of the first substrate 100 may constitute a sealing pattern 300. The sealing pattern 300 may exhibit a rectangular shape when viewed from a plan view, as illustrated in FIG. 6B. A second dispenser 20 may be located over the first substrate 100. A liquid crystal material 401 may be supplied into the second dispenser 20, and the second dispenser 20 may dispense the liquid crystal material 401 on the first substrate 100 which is surrounded by the sealing pattern 300.

Referring to FIG. 6C, a second substrate 200 is disposed on the sealing pattern 300 to face the first substrate 100. The second substrate 200 may be a transparent substrate. The second substrate 200 may be spaced apart from the first substrate 100 by a thickness of the sealing pattern 300. Thus, a space may be provided between the first and second substrate 100 and 200, and the space may be filled with a liquid crystal layer 400 which includes the liquid crystal material 401.

Referring to FIG. 6D, a light source 30 may be provided over the second substrate 200 after removal of the first and second dispensers 10 and 20. Lights from the light source 30 may be then irradiated onto the second substrate 200 to reach the sealing pattern 300. The sealing pattern 300 may be cured by the lights from the light source 30. The sealing pattern 300 may comprise the acrylic type compound, and the acrylic type compound may comprise at least one of the first to fourth compounds which are expressed by the chemical formulas 1 to 4, respectively. The acrylic type compound may have high photo reactivity, as describe above. Thus, the sealing pattern 300 may be easily and rapidly cured by the lights from the light source 30. As a result, it may prevent the liquid crystal layer 400 from being contaminated by an uncured portion of the sealing pattern 300 during irradiation of the lights.

Referring to FIG. 6E, the substrate set including the cured sealing pattern 300 may be moved onto a hot plate 2. The first and second substrates 100 and 200 and the sealing pattern 300 may be thermally treated by heat generated from the hot plate 2. The sealing pattern 300 may comprise the epoxy type compound having epoxy groups, and the epoxy type compound may be cured during the thermal treatment process. Further, the sealing pattern 300 may include a dihydrazide compound which has 4-isopropyl-2,5-dioxoimidazolidine-1,3-di(propyonohydrazide) and adipic acid dihydrazide. The dihydrazide compound may provide stable adhesion between the substrates 100 and 200 and the sealing pattern 300 during the thermal treatment process, thereby significantly suppressing thermal expansion and warp of the substrates 100 and 200. Thus, a misalignment between the first and second substrates 100 and 200 may be avoided.

According to the embodiments described above, a sealing pattern may be formed of a sealant which includes an acrylic type compound, an epoxy type compound and a dihydrazide compound. The sealing pattern is used as an adhesive between a pair of substrates which act as liquid crystal display panels. Thus, it may prevent a liquid crystal layer disposed between the pair of substrates from being contaminated by the sealing pattern while the sealing pattern is cured. Further, the sealing pattern may significantly suppress thermal expansion and warp of the substrates during cure of the sealing pattern. As a result, a misalignment margin between the pair of substrates may be enhanced because of the presence of the sealing pattern.

Although the present invention has been described in connection with the embodiment of the present invention illustrated in the accompanying drawings, it is not limited thereto. It will be apparent to those skilled in the art that various substitutions, modifications and changes may be made without departing from the scope and spirit of the invention.

What is claimed is:

1. A sealant, comprising:
an acrylic type compound having at least two acrylic groups per one molecule;
an epoxy type compound having at least one epoxy group per one molecule; and
a dihydrazide compound including 4-isopropyl-2,5-dioxoimidazolidin-1,3-di(propyonohydrazide) and adipic acid dihydrazide.

2. The sealant as set forth in claim 1, wherein the acrylic type compound comprises at least one selected from the group consisting of first to fourth compounds which are expressed by the following chemical formulas 1 to 4 respectively, and wherein “R” in each of the chemical formulas 1 to 4 denotes a hydrocarbon group and “n” in the chemical formula 4 denotes a natural number:

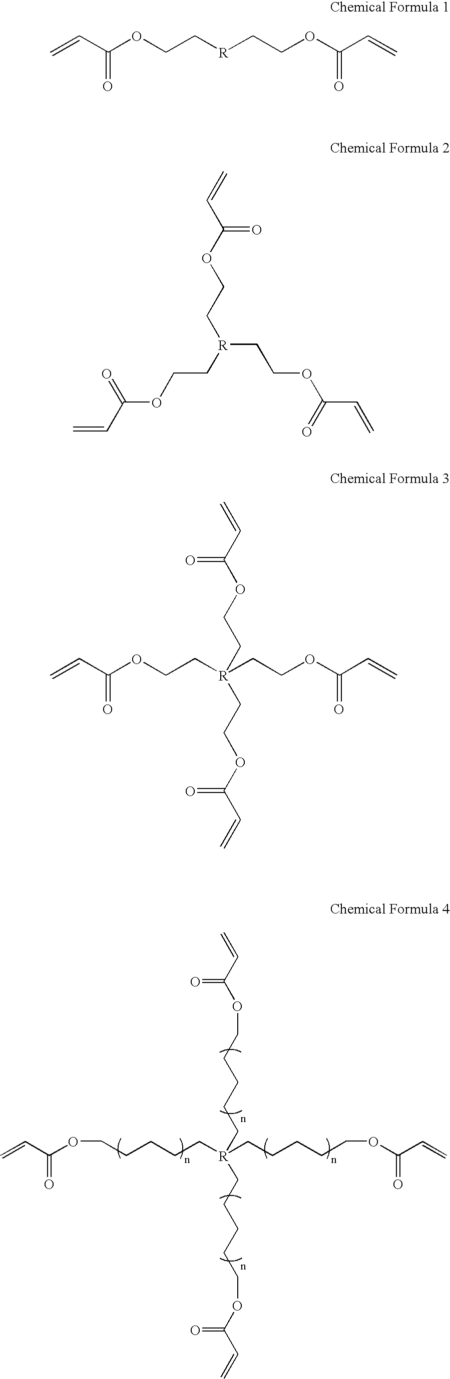

3. The sealant as set forth in claim 1, wherein a weight percentage of the 4-isopropyl-2,5-dioxoimidazolidin-1,3-di(propyonohydrazide) is greater than a weight percentage of the adipic acid dihydrazide in the dihydrazide compound.

4. The sealant as set forth in claim 3, wherein a weight ratio of the 4-isopropyl-2,5-dioxoimidazolidin-1,3-di(propyonohydrazide) to the adipic acid dihydrazide is between about 7:2 and about 9:2.

5. The sealant as set forth in claim 1, wherein a weight percentage of the acrylic type compound is greater than a weight percentage of the epoxy type compound.

6. The sealant as set forth in claim 5, wherein a weight ratio of the acrylic type compound to the epoxy type compound is between about 1:1 and about 5:1.

7. The sealant as set forth in claim 1, further comprising:
a hybrid compound having an acrylic group and an epoxy group;
an inorganic filler; and
an organic filler.

8. The sealant as set forth in claim 7, wherein the acrylic type compound has a content of 32 wt % to 38 wt %, the epoxy type compound has a content of 23 wt % to 29 wt %, the hybrid compound has a content of 7 wt % to 11 wt %, the dihydrazide compound has a content of 8 wt % to 12 wt %, the inorganic filler has a content of 12 wt % to 16 wt %, and the organic filler has a content of 3 wt % to 7 wt %.

9. A display device, comprising:
a first substrate having a display area;
a second substrate facing the first substrate; and
a sealing pattern disposed between the first and second substrates to attach the first substrate to the second substrate, the sealing pattern including a sealant, comprising:
an acrylic type compound having at least two acrylic groups per one molecule;
an epoxy type compound having at least one epoxy group per one molecule; and
a dihydrazide compound including 4-isopropyl-2,5-dioxoimidazolidin-1,3-di(propyonohydrazide) and adipic acid dihydrazide.

10. The display device as set forth in claim 9, wherein the acrylic type compound comprises at least one selected from the group consisting of first to fourth compounds which are expressed by the following chemical formulas 1 to 4 respectively, and wherein “R” in each of the chemical formulas 1 to 4 denotes a hydrocarbon group and “n” in the chemical formula 4 denotes a natural number:

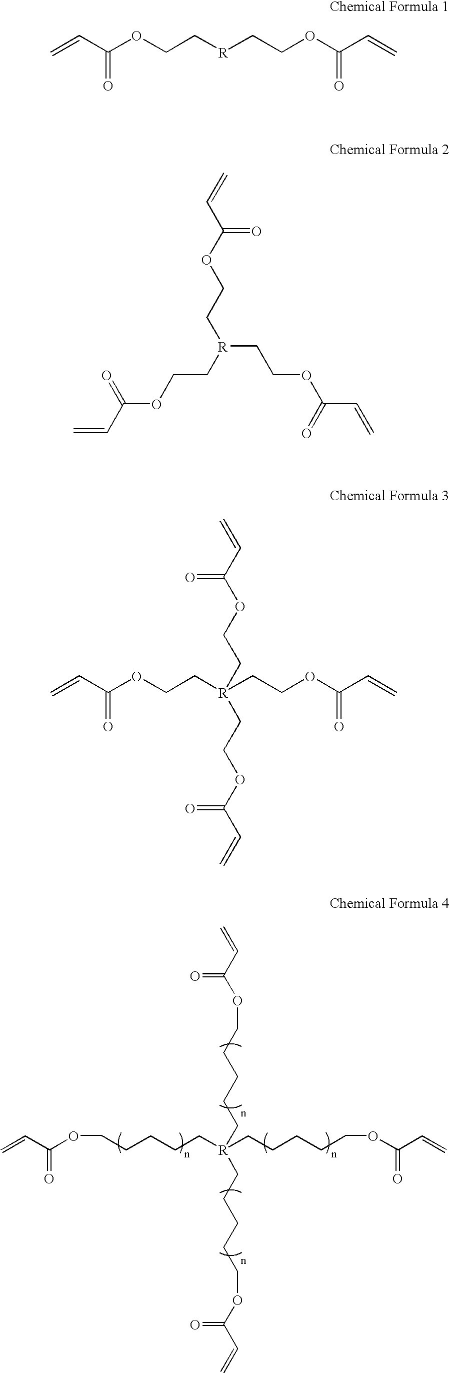

11. The display device as set forth in claim 9, wherein a weight percentage of the 4-isopropyl-2,5-dioxoimidazolidin-1,3-di(propyonohydrazide) is greater than a weight percentage of the adipic acid dihydrazide in the dihydrazide compound.

12. The display device as set forth in claim 11, wherein a weight ratio of the 4-isopropyl-2,5-dioxoimidazolidin-1,3-di(propyonohydrazide) to the adipic acid dihydrazide is between about 7:2 and about 9:2.

13. The display device as set forth in claim 9, wherein a weight percentage of the acrylic type compound is greater than a weight percentage of the epoxy type compound in the sealant.

14. The display device as set forth in claim 13, wherein a weight ratio of the acrylic type compound to the epoxy type compound is between about 1:1 and about 5:1.

15. The display device as set forth in claim 9, wherein the sealant further comprises:
a hybrid compound having an acrylic group and an epoxy group;
an inorganic filler; and
an organic filler.

16. The display device as set forth in claim 15, wherein the acrylic type compound has a content of 32 wt % to 38 wt %, the epoxy type compound has a content of 23 wt % to 29 wt %, the hybrid compound has a content of 7 wt % to 11 wt %, the dihydrazide compound has a content of 8 wt % to 12 wt %, the inorganic filler has a content of 12 wt % to 16 wt %, and the organic filler has a content of 3 wt % to 7 wt %.

17. The display device as set forth in claim 9, further comprising a liquid crystal layer disposed between the first and second substrates.
